(19) United States
(12) Patent Application Publication
(10) Pub. No.: US 2002/0095621 A1
(43) Pub. Date: Jul. 18, 2002

(54) Method and system for modifying search criteria based on previous search date

(76) Inventor: Scott S. Lawton, Chelmsford, MA (US)

Correspondence Address: FOLEY, HOAG & ELIOT, LLP, PATENT GROUP, ONE POST OFFICE SQUARE, BOSTON, MA, 02109, US

(21) Appl. No.: 09/970,158

(22) Filed: Oct. 2, 2001

Related U.S. Application Data
(60) Provisional application No. 60/237,252, filed on Oct. 2, 2000.
(60) Provisional application No. 60/238,577, filed on Oct. 6, 2000.
(60) Provisional application No. 60/238,791, filed on Oct. 6, 2000.
(60) Provisional application No. 60/238,587, filed on Oct. 6, 2000.
(60) Provisional application No. 60/238,754, filed on Oct. 6, 2000.
(60) Provisional application No. 60/237,249, filed on Oct. 2, 2000.
(60) Provisional application No. 60/237,254, filed on Oct. 2, 2000.
(60) Provisional application No. 60/237,250, filed on Oct. 2, 2000.
(60) Provisional application No. 60/237,243, filed on Oct. 2, 2000.

(51) Int. Cl. H04L 1/22

(52) U.S. Cl. 714/36

(57) ABSTRACT

A method and system for modifying stored search criteria so that it will locate only those data objects that have been added and/or updated since the date on which the user previously invoked the stored search criteria. This invention reduces the time and frustration associated with repeated searches, by automatically showing only new or modified data objects with no additional effort required by the user.

### REFERENCE TO RELATED APPLICATIONS

This application claims the benefit of and incorporates by reference the following applications:

U.S. Provisional Application Serial No. 60/237,250 filed on Oct. 2, 2001; Method and System of Entering Search Criteria Using Multiple Entry Fields per Data Element, U.S. Serial No. 60/238,577 filed Oct. 6, 2000; Method and System for Combining User-Supplied Sort Information with Secondary Sort Information, U.S. Serial No. 60/238,791 filed Oct. 6, 2000; Method and System for Organizing Information into Visually Distinct Groups Based on User Input, U.S. Serial No. 60/238,587 filed Oct. 6, 2000; Enhanced Method and System for Viewing Any Search Result Without Returning to the Result List, U.S. Serial No. 60/238,754 filed Oct. 6, 2000; Method and System for Pre-Filling Search Criteria into a Form, U.S. Serial No. 60/237,249 filed Oct. 2, 2000; Enhanced Method and System for Storing and Managing Search Criteria, U.S. Serial No. 60/237,254 filed Oct. 2, 2000; Method and System for Organizing Search Results into a Single Page Showing Two Levels of Detail; Method and System for Modifying Search Criteria Based on Previous Search Date, U.S. Serial No. 60/237,250 filed Oct. 2, 2000; and Enhanced Method and System for Category Selection, U.S. Serial No. 60/237,243 filed Oct. 2, 2000.

### COPYRIGHT NOTICE

The following patent disclosure includes material that is subject to copyright protection. The copyright owner has no objection to the facsimile reproduction of the disclosure by any person as it appears in the records of the U.S. Patent and Trademark Office, but otherwise reserves all rights to the copyright whatsoever.

### FIELD OF THE INVENTION

The invention relates generally to information retrieval from data repositories, and more particularly to an enhanced method and system for storing search criteria and managing the stored search criteria, whereby the user spends less time and effort on repetitive searches.

### BACKGROUND OF THE INVENTION

As a society, we are increasingly becoming both dependent on and overloaded with information, especially data that is stored in computer databases or full-text collections. As the quantity of information stored in these data repositories increases, the complexity of retrieving relevant information also increases. To locate information, users search general collections (e.g., AltaVista, Excite, InfoSeek, Lycos, Yahoo, etc.) as well as specialized sources which may be implemented with back-end databases, such as those dedicated to locating employment opportunities (e.g., CareerBuilder, CareerPath, Headhunter.net, HotJobs, Monster.com, etc.). According to recent studies from technology analysts (e.g., the Jupiter Group and Forrester Research), Internet searching is the most common online activity next to sending/receiving e-mail communications.

Data repositories may take on several forms, including relational databases, hierarchical databases, and flat-file databases, all of which support and may require searching within specific fields or columns, and full-text collections which may or may not support searching within fields or delimited portions of documents that are represented as fields, and/or one or more documents. As used herein, the term “data element” refers to a database field, a delimited portion of a document, meta information associated with a document, or to an entire document. As used herein, the term “data object” refers to a database record, a document, or some other grouping of associated data elements. As used herein, the term “data unit” refers to the value or contents of a data element. As used herein, the term “page” refers to a document or page on the World Wide Wide or other public or private network, e.g. a continuously scrollable body of information which may or may not include so-called “frames,” (i.e. portions that do not scroll automatically when other portions of the page are scrolled). As used herein, the term “query” will be used as a synonym for the phrase “search criteria.”

Although many searches are “ad hoc,” using completely different search criteria for each visit, other searches are likely to use similar or even identical search criteria on subsequent visits. Examples include searching job openings, resumes of job seekers, apartments for rent, houses for sale, etc. Some search Web sites let you save search criteria by name and recall the named search criteria in a subsequent visit. In addition, some of these and other Web sites offer search agents that invoke a stored query on a certain schedule. However, no known site stores and displays the date that the stored query was mostly recently invoked; no known site stores and displays the date used in that query, if any; and no known site modifies the search criteria based on the date that the user most recently invoked the stored query.

In summary, the prior art does not provide effective and convenient ways to adapt stored search criteria based on the date of user actions.

### SUMMARY OF THE INVENTION

In the present invention, a computer with appropriate software modifies stored search criteria so that it will locate only those data objects that have been added and/or updated since the date on which the user previously invoked the stored search criteria.

The present invention overcomes prior art limitations by storing both the date of the previous search and the date used in the previous search, replacing the latter with the former for a new search.

It is an object of the invention to reduce the time and frustration associated with repeated searches, by automatically showing only new or modified data objects with no additional effort required by the user.

Other objects and advantages of the invention will, in part, be obvious, and, in part, be shown from the following description.

### BRIEF DESCRIPTION OF THE DRAWINGS

FIG. 1 is a schematic representation depicting the components of one embodiment of the invention;

FIG. 2 depicts one illustrative embodiment of the inventions's Query List user interface as an HTML form.

FIGS. 3a and 3b are flow charts depicting the steps of formatting and filtering;

FIG. 4 is a schematic representation depicting one illustrative embodiment of the invention, wherein the invention is coupled to a network;

FIG. 5 is a schematic representation depicting one illustrative embodiment of the invention, wherein the invention interacts with a single electronic device.

### LIST OF REFERENCE NUMERALS

10 system components

12 formatter

14 identifier input port

18 summary output port

20 storage

22 filter

24 identifier input port

26 name input port 28 query output port

30 computer

50 system with network

52A-52C IADs

54A-54C Web browsers

56 network

58 HTTP Web server

62 search engine

64 data repository

68 server computer

90 system with single electronic device

### DESCRIPTION OF THE ILLUSTRATIVE EMBODIMENTS

To provide an overall understanding of the invention, certain illustrative embodiments will now be described. However, it will be understood by one of ordinary skill in the art that the methods and systems described herein may be adapted and modified for other suitable applications and that such other additions and modifications will not depart from the spirit and scope of the inventive concept.

To more clearly and concisely describe the subject matter of the invention, the following definitions are intended to provide guidance as to the meaning of specific terms used in the following written description, examples, and appended claims. As used herein, the term or phrase:

“communications network” and “network” include a LAN, a MAN, a WAN, an Intranet, an Extranet, the Internet, a wireless network (e.g., according to the WAP protocol), and the like;

“Information Location Mechanism” (hereinafter “ILM”) includes software, firmware and/or systems capable of searching a data repository to locate information that meets search criteria, such systems including database management systems, search engines supporting full-text search, search engines supporting fielded search, search engines supporting regular expressions and/or other patterns, and/or iterative search engines;

“Information Sorting Mechanism” (hereinafter “ISM”) includes software, firmware and/or systems capable of ordering data objects according to sort criteria, such systems including database management systems, text processing library routines, etc.;

“Internet Access Device” (hereinafter “IAD”) includes personal computer systems (hereinafter “PCs”), computer workstations, desktop computers, laptop computers, hand-held computers, television set-top boxes, wireless access devices such as mobile telephones, cellular telephones, pagers, beepers, and other various hand-held wireless devices, and all other devices that have at least one processor, UD and VDU, and are capable of accessing the Internet and/or other networks;

“processor” includes all components, devices, Integrated Circuits (hereinafter “ICs”), modules, software, subsystems, and/or systems that provide control and/or perform arithmetic and logical operations and/or extract computer instructions and/or decode computer instructions and/or execute computer instructions, such as a Central Processing Unit (hereinafter “CPU”), a microprocessor, a controller, and the like; including any associated memory or other electronic storage of data and/or instructions;

“User-input Device” (hereinafter “UD”) includes keyboards, keypads, mice, trackballs, trackpads, wheels, joysticks, graphics tablets, voice recognition devices, motion sensing devices and other devices for one or more users to enter text, numbers or other data and/or for pointing, clicking, tapping, selecting, dragging and/or other gestures or actions;

“Visual Display Unit” (hereinafter “VDU”) includes CRT screens, monitors, video display terminals, LCD screens, LED screens, digital paper, and all other devices that are capable of displaying analog or digital data;

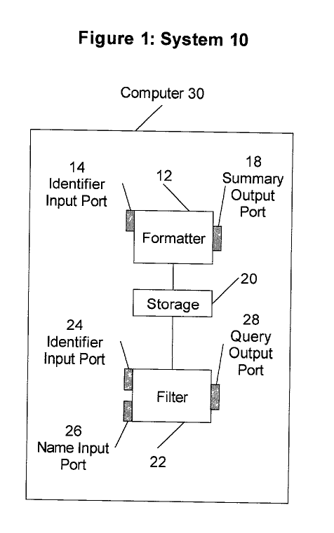

FIG. 1 depicts an illustrative embodiment of one system 10 according to the invention which modifies search criteria based on the previous search date. The system comprises a formatter 12 containing an identifier input port 14 and a summary output port 18. The formatter 12 is coupled with storage 20, which is in turn coupled with a filter 22 containing an identifier input port 24, a name input port 26, and a query output port 28.

For this illustrative embodiment, the formatter 12 with ports 14 and 18, the storage 20 and the filter 22 with ports 24, 26 and 28 reside on a single computer 30 which may be a Macintosh G3 running MacOS 8.5. For this illustrative embodiment, the formatter 12 and the filter 22 are coded in the UserTalk language embedded in UserLand Frontier, a commercial scripting and Web development system. For this illustrative embodiment, storage 20 is an object database in UserLand Frontier.

It will be readily apparent to those skilled in the art that the computer 30 could be a different Macintosh computer running a different version of MacOS or a different OS such as Linux, or an Intel or Intel-compatible PC or server running a version of the Microsoft Windows operating system such as Windows 98, Windows NT or Windows 2000, or an Intel or Intel-compatible PC or server running Linux or FreeBSD or other UNIX OS, or a computer from Sun, HP, IBM or other company, running Solaris, HP-UX, AIX or other variation of UNIX or other OS.

It will be readily apparent to those skilled in the art that the functions performed in this embodiment with a single computer 30 could be divided among a plurality of computers from the same or different manufacturers, with each computer running the same or different operating systems.

It will be readily apparent to those skilled in the art that formatter 12 and/or filter 22 could be coded in any suitable scripting or programming language such as Perl, JavaScript, Java, VBScript, Visual BASIC, C++, etc. or any suitable Web development system such as Vignette StoryServer, Allaire ColdFusion, SilverStream, etc., and that formatter 12 and filter 22 need not be coded in the same language or system.

It will be readily apparent to those skilled in the art that storage 20 could be implemented with a file or files stored on a computer-readable medium, with a database management system, or using other well-known storage techniques.

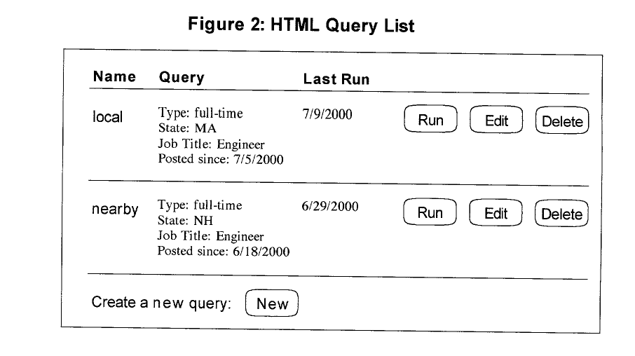

FIG. 2 depicts one illustrative embodiment of the query list as an HTML form with buttons. In this embodiment, the query list is comprised of a header row with the labels “Name,” “Query,” and “Last Run,” followed by a row for each saved query separated by a horizontal line for each, with each row listing the name, query, and last run date and three action buttons labelled “Run,” “Edit,” and “Delete.” In this embodiment, the set of query rows is followed by a row containing a label “Create a new query” and a button labelled “New.”

With this embodiment of the invention, users can see at a glance for each query the entire search criteria including the date that is part of the criteria, and the date on which the query was last run. When users activate the “Run” button, the system will modify the search criteria's date to be the last run date and set the last run date to the current date. With this embodiment of the invention, users can create a new query without leaving the page. The invention may be configured to, upon the user activating the “Edit” button, fill the search criteria into the standard search form so that users save time and reduce the effort required to learn the system by using one form for creating and editing search criteria.

It will be readily apparent to those skilled in the art that the interface could vary in many ways, such as by omitting certain elements (e.g. the query name) or adding other elements, arranging the elements in a different manner on the form, etc. it will be readily apparent to those skilled in the art that the interface could be modified to apply to other domains, e.g. with data elements such as “Skills” to search resumes of job seekers, or “Amenities” to search apartments for rent, or “Location” to search houses for sale, etc.

It will be readily apparent to those skilled in the art that the interface could be presented in many fashions, e.g. as an XML form, a PDF form, a form implemented in a Java applet or Active X control, a form implemented using desktop or client-server software, or otherwise.

Operation

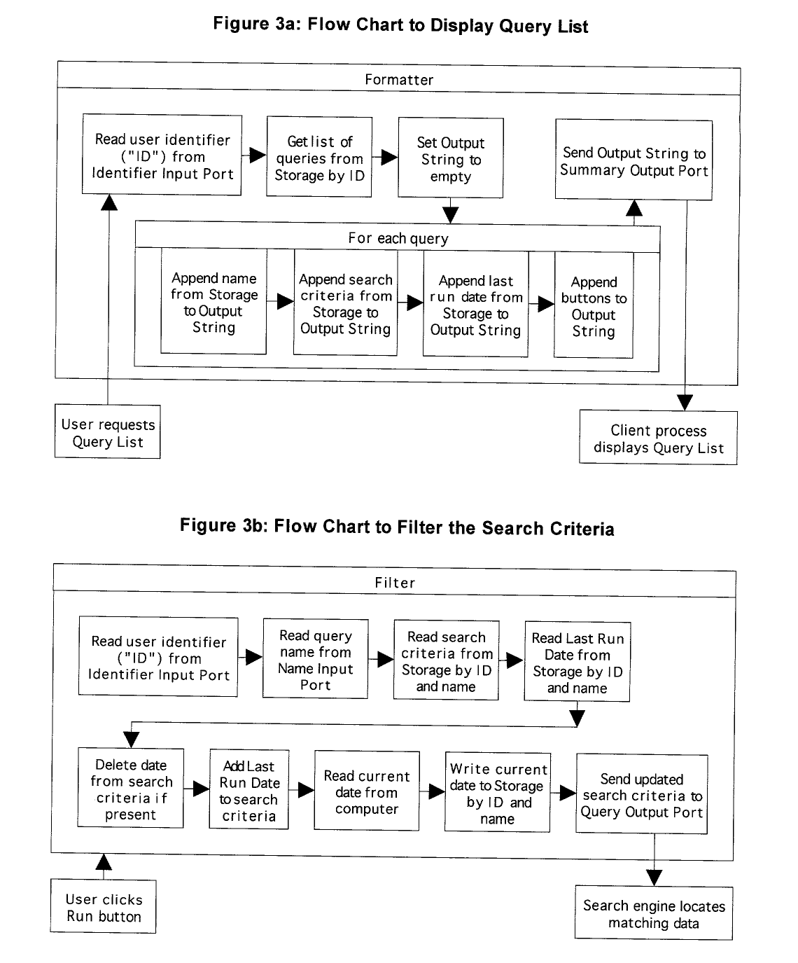

FIG. 3a is a flow chart that depicts one sequence of formatting the query list for this illustrative embodiment. Initially, a user requests the query list. The formatter 12 reads the user identifier (“ID”) from identifier input port 14, gets a list of queries from storage 20 by ID, and sets a variable called Output String to empty. For each query, formatter 12 reads the name from storage 20 and appends the name to the Output String, reads the search criteria from storage 20 and appends the search criteria to the Output String, reads the last run date from storage 20 and appends the last run date to the Output String, and appends the action buttons to the Output String. The formatter 12 then sends the Output String to the summary output port 18 for display as a query list by a client process for the user.

FIG. 3b is a flow chart that depicts one sequence of filtering a query for this illustrative embodiment. When the user activates the “Run” button, filter 22 reads the user identifier (“ID”) from identifier input port 24, reads the query name from name input port 26, reads the search criteria from storage 20 by name and user ID, reads the last run date from storage by name and user ID, deletes the date from the search criteria if present, adds the last run date to the search criteria, reads the current date from the computer 30, and writes the current date to storage 20 by name and user ID. Filter 22 then sends the updated search criteria to query output port 28 for subsequent use by a search engine.

It will be readily apparent to those skilled in the art that the same result could be accomplished with variations on these two sequences, such as by reading or appending items in a different order. It will be further apparent that by keeping different data in storage 20, the inputs could vary somewhat, such as by organizing the user ID and query name according to a single query ID and/or a session ID. It will be further apparent that formatter 12 and filter 22 could accept and process information in a variety of formats, each of which may differ from the other.

Alternative Embodiments

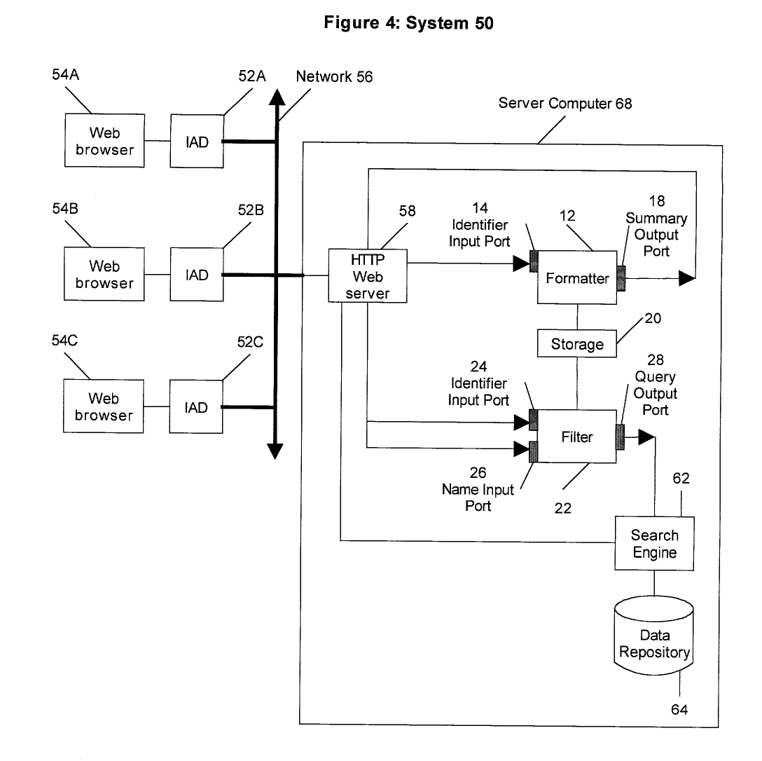

FIG. 4 depicts another illustrative embodiment of one system 50 according to the invention which modifies search criteria provided over a network based on the previous search date. The system comprises a plurality of IADs 52A-52C, each integrated with or coupled to a client process such as a Web browser 54A-54C and coupled to a network 56, which is in turn coupled to an HTTP Web server 58, which is coupled to formatter 12 via identifier input port 14. The formatter 12 is also coupled via summary output port 18 to HTTP Web server 58 in order to return the query list page with action buttons to the IADs 52A-52C to display for the users on client processes such as Web browsers 54A-54C.

The formatter 12 is coupled with storage 20, which is in turn coupled with a filter 22 containing an identifier input port 24 and a name input port 26 which are coupled to HTTP Web server 58. The filter 22 is coupled via query output port 28 to search engine 62, which is in turn coupled to data repository 64, and to HTTP Web server 58 to return matching data objects to the IADs 52A-52C to display for the users on client processes such as Web browsers 54A-54C.

For this illustrative embodiment, the HTTP Web server 58, search engine 62, data repository 64, formatter 12 with ports 14 and 18, storage 20, and filter 22 with ports 24, 26 and 28, reside on a single server computer 68.

It will be readily apparent to those skilled in the art that the functions performed in this embodiment with a single server computer 68 could be divided among a plurality of server computers from the same or different manufacturers, with each computer running the same or different operating systems.

It will be readily apparent to those skilled in the art that the HTTP Web server 58 could be WebStar, WebTen, Microsoft IIS, Apache or other commercial or open source Web server or Web development system, such as UserLand Frontier, which includes a built-in Web server. It will be readily apparent to those skilled in the art that formatter 12, filter 22, and other components could interact with HTTP Web server 58 via CGI, plug-in, servlets, Enterprise Java Beans, etc.

It will be readily apparent to those skilled in the art that search engine 62 and data repository 64 could be any suitable database management system such as Oracle, Informix, Sybase, SQL Server, Access, mySQL, PostgreSQL, etc. or full-text search engine and associated collection or other index mechanism such as those provided by Verity, UltraSeek, Thunderstone, etc., and/or other software capable of storing and searching data. It will be further apparent that search engine 62 and data repository 64 need not be implemented using the same software nor even reside on the same computer.

Operation:

The user controls one or more UDs to request the query list via a Web browser 54 running on an IAD 52. The Web browser 54 sends the request over the network 56 via the HTTP protocol to the HTTP Web server 58 running on the server computer 68, which forwards the request to formatter 12. The formatter 12 reads the user identifier (“ID”) from identifier input port 14, gets the name, search criteria and last run date from storage 20 for each of the specified user's queries, then sends this data and the action buttons as an HTML page via summary output port 18 to HTTP Web server 58, which returns the HTML page over the network 56 via the HTTP protocol back to the user's Web browser 54 which displays it on the VDU of IAD 52.

When the user activates the “Run” button using the UD, Web browser 54 running on an IAD 52 sends the query name and a user ID via the HTTP protocol to HTTP Web server 58 from which filter 22 reads the user identifier (“ID”) via identifier input port 24, and the query name via name input port 26. The filter 22 then reads the search criteria from storage 20 by name and user ID, reads the last run date from storage by name and user ID, updates the search criteria with the last run date, updates the last run date in storage 20, then sends the updated search criteria via query output port 28 to search engine 62. Search engine 62 locates matching data in data repository 64 and sends the data objects as an HTML page to HTTP Web server 58, which returns the HTML page over the network 56 via the HTTP protocol back to the user's Web browser 54 which displays it on the VDU of IAD 52.

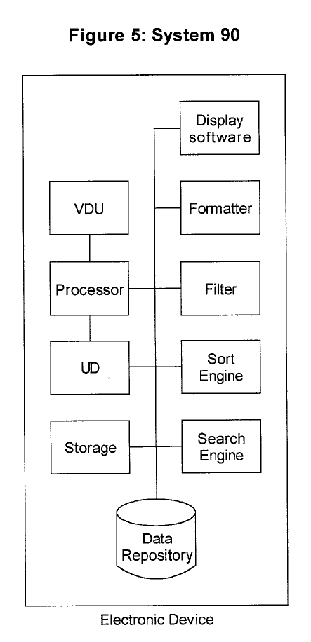

FIG. 5 depicts an illustrative embodiment of one system 90 according to the invention. The system comprises a single electronic device with at least one processor, at least one UD, at least one VDU and some form of storage, with the system 90 running software configured as one or more components to display the query list, accept user input, store and retrieve data using formatter 12 and filter 22, perform a search on a local or embedded data repository, sort the results, and return the results to the user.

It will be readily apparent to those skilled in the art that, as depicted in FIG. 5, the formatter 12 and/or filter 22 may have direct access to storage 20 and/or to search engine 62 and/or to data repository 64 and/or to a sort engine, reading the data from one or more locations according to the particular embodiment. It will be further apparent from FIG. 5 that search engine 62, data repository 64 and the sort engine have direct access to each other, such that any could access data on behalf of any other component according to the particular embodiment.

It will be readily apparent to those skilled in the art that one or more of the depicted individual components could be moved to a different device, situated locally or remotely, to, for example, support a remote data repository or have certain functions performed remotely.

As previously indicated, those skilled in the art will know or be able to ascertain using no more than routine experimentation, many equivalents to the illustrative embodiments and practices described herein. It will also be understood that the methods and systems described herein provide advantages over the prior art by updating stored search criteria based on the previous search date, reducing the time and frustration associated with repeated searches. Accordingly, the scope of the invention should be determined not by the embodiments disclosed herein, but by the following claims, which are to be interpreted as broadly as allowed under the law.

Furthermore, it is to be understood that the terminology used herein is for the purpose of describing particular illustrative embodiments only and is not intended to be limiting. It must be noted that as used herein, including the appended claims, the singular forms “a,” “an,” and “the” include plural referents unless the context clearly dictates otherwise.

What is claimed is:

1. A Date-adaptive Query Management System (DQMS) for modifying search criteria based on the previous search date, the DQMS comprising:
an identifier input port configured to receive a user identifier (“ID”);
a name input port configured to receive a query name;
a query output port configured to send query to an Information Location Mechanism (ILM) and/or to the mechanism that invoked the DQMS;
a storage mechanism;
a filter configured to:
receive the user identifier from the identifier input port,
receive the query name from the name input port,
read search criteria from the storage mechanism by ID and name,
read the last run date from the storage mechanism by ID and name,
if the search criteria includes a date, delete it,
add the last run date to the search criteria,
read the current date from the system hosting the DQMS,
write the current date to the storage mechanism by ID and name, and
send the updated search criteria to the query output port;
whereby invoking the stored query will automatically locate only new or modified data objects with no additional effort required by the user, making repeated searches faster and easier.

2. The DQMS recited in claim 1 wherein the name input port is configured to receive a query ID instead of a query name, and wherein the filter is configured to use the query ID in place of the query name.

3. The DQMS recited in claim 2 wherein the filter is configured to read the user identifier from storage by query ID rather than reading it from the identifier input port.

4. The DQMS recited in claim 1 wherein the name input port is configured to receive search criteria instead of a query name, and wherein the filter is configured to use the search criteria directly rather than reading it from the storage mechanism.

5. The DQMS recited in claim 1, further including:
a summary output port configured to send query information and at least one action trigger to a client process for display on a Visual Display Unit (VDU) and/or to the mechanism that invoked the DQMS;
a formatter configured to:
receive the user identifier from the identifier input port,
read from storage information about every query stored by the user, and
send the query information to the summary output port;
whereby the user receives a summary list of information about each query.

6. The DQMS recited in claim 5 wherein the returned information includes the name of each stored search criteria.

7. The DQMS recited in claim 5 wherein the returned information includes the stored search criteria.

8. The DQMS recited in claim 5 wherein the returned information includes the last run date.

9. The DQMS recited in claim 5 wherein the returned information is merged with a search form.

10. The DQMS recited in claim 5 wherein the returned information includes at least one action trigger for each stored query.

11. The DQMS recited in claim 10 wherein the action trigger is at least one of the following:
“Run,”
“Edit,” and/or
“Delete.”

12. The DQMS recited in claim 5 wherein the result information and/or action trigger employs a markup language including HTML, XML and/or SGML.

13. The DQMS recited in claim 5 wherein the result information and/or action trigger employs a portable document format.

14. The DQMS recited in claim 5 wherein the result information and/or action trigger employs script and/or program code.

15. The DQMS recited in claim 1 wherein the user identifier is derived from at least one of the following:
a Web “cookie”,
HTTP authentication,
a parameter in an HTML form, and/or
Windows NT authentication.

16. The DQMS recited in claim 1 wherein the identifier input port, the name input port, the query output port, and/or the storage mechanism is/are coupled to an HTTP Web server, or coupled to a computer-readable media, or configured to communicate via a standard electronic messaging protocol.

17. The DQMS recited in claim 1 wherein the ILM is a database management system, a search engine supporting full-text search, a search engine supporting fielded search, a search engine supporting regular expressions and/or other patterns, and/or an iterative search engine.

18. The DQMS recited in claim 1 wherein the search criteria includes at least one data element of employment information.

19. A search system comprising:
a DQMS as recited in claim 1;
an ILM coupled to a data repository containing a plurality of data objects, the ILM being configured to receive the search criteria in a predetermined syntax, search the data repository, and retrieve zero or more data objects that conform to the search criteria;
a formatting engine configured to format the search results from the ILM; and
a client process and VDU to display the search form, the formatted search results and the action trigger.

20. The search system recited in claim 19 wherein the search form employs a markup language such as HTML, XML or SGML.

21. The search system recited in claim 19 wherein the contents of at least one data element of at least one data object include employment information.

22. The search system recited in claim 19, further including:
a sort port configured to receive sort criteria;
an Information Sorting Mechanism (ISM) coupled between the ILM and the formatting engine; the ISM being configured to receive the sort criteria in a predetermined syntax, receive a plurality of data objects from the ILM, sort the data objects according to the sort criteria, and forward the sorted data objects to the formatting engine.

23. A data-adaptive query management method for modifying search criteria based on the previous search date, the method comprising:
receiving a user identifier (“ID”),
receiving a query name,
reading search criteria by ID and name,
reading the last run date by ID and name,
if the search criteria includes a date, deleting it,
adding the last run date to the search criteria,
reading the current date,
writing the current date by ID and name, and
sending the updated search criteria to an Information Location Mechanism (ILM) and/or to the mechanism that invoked the method;
whereby invoking the stored query will automatically locate only new or modified data objects with no additional effort required by the user, making repeated searches faster and easier.
